(19) United States
(12) Patent Application Publication
(10) Pub. No.: US 2007/0264500 A1
(43) Pub. Date: Nov. 15, 2007

(54) Polypropylene-Based Monofilaments With Improved Properties

(76) Inventor: Claudia Petra Fritz, Neuenkirch (CH)

Correspondence Address: LADAS & PARRY, 26 WEST 61ST STREET, NEW YORK, NY, 10023, US

(21) Appl. No.: 11/547,156

(22) PCT Filed: Mar. 22, 2005
(86) PCT No.: PCT/FR05/00687

§ 371 Date: Jul. 17, 2007

(30) Foreign Application Priority Data
Mar. 30, 2004 (FR) 0403282

(51) Int. Cl. D02G 3/00; B28B 3/00

(52) U.S. Cl. 428/364; 264/623

(57) ABSTRACT

The invention relates to polypropylene-based monofilaments having improved properties, especially an improved abrasion resistance, to a process for manufacturing these monofilaments and to their use. The invention relates more particularly to polypropylene-based monofilaments, the polypropylene being obtained by polymerizing propylene in the presence of a metallocene catalyst.

The invention relates to polypropylene-based monofilaments having improved properties, especially an improved abrasion resistance, to a process for manufacturing these monofilaments and to their use. The invention relates more particularly to polypropylene-based monofilaments, the polypropylene being obtained by polymerizing propylene in the presence of a metallocene catalyst.

Two-dimensional textile articles made of polypropylene are of great interest as chemically and mechanically resistant filtration means for filtration in the chemical, pharmaceutical and food industries. In particular, relatively coarse monofilaments, having a diameter of greater than 0.050 mm, are required in this field.

Monofilaments made of pure polypropylene have the drawback of forming a great deal of dust as a result of the low resistance of this substance to abrasion during the weaving process. The problem of abrasion is also known in the case of other thermoplastics. Thus EP-A2-0 784 107 mentions melt-spun, polyamide, polyester or polypropylene monofilaments that are intended for paper machine forming fabrics and for strimmer lines. According to the above patent, abrasion-resistant monofilaments are obtained using 70 to 99% by weight of fibre-forming polymer and 1 to 30% by weight of a maleic-anhydride-modified polyethylene/polypropylene rubber and other additives. However, the examples are limited, as regards the fibre-forming polymer, to the polyamide nylon-6 and to polyethylene terephthalate, and also to a PA-6,6/PA-6 copolyamide. The spinning rates are not mentioned.

A process for manufacturing polypropylene multifilaments intended for textile applications is also known from EP-A-1 059 370. As starting material, an isotactic polypropylene is used that has a melt flow index greater than 19 g per 10 minutes. FOY (Fully Oriented Yarn) multifilaments of 10 dpf (denier per filament) [0.03953 mm diameter] and POY (Partially Oriented Yarn) multifilaments of 2 dpf (denier per fibre) [0.01768 mm diameter] have been described. As regards the yarns manufactured, only general indications are given. Monofilaments are not described.

Applications WO 02/086207 and WO 03/048434 describe polypropylene monofilaments, the polypropylene including additives. The polypropylene employed for manufacturing the monofilaments has a melt flow index of greater than or equal to 6 g per 10 minutes. These monofilaments have correct abrasion resistance properties.

One problem of the invention consists in how to provide polypropylene-based monofilaments that are more abrasion resistant than the monofilaments known from the prior art. Another problem of the invention consists in how to obtain polypropylene-based monofilaments that exhibit better abrasion resistance during weaving.

Yet another problem consists in how to provide for the use of monofilaments possessing good abrasion resistance for the manufacture of two-dimensional high-performance articles, especially those intended for filtration.

The problems are solved according to the invention in particular by the use, for the manufacture of the monofilaments, of a polypropylene obtained by polymerizing propylene in the presence of a metallocene catalyst.

The polypropylenes conventionally used in the manufacture of monofilaments are isotactic polypropylenes.

The term “metallocene” is understood to mean a coordination compound (ferrocene, cobaltocene, nickelocene, titanocene, zirconocene, uranocene, etc.) obtained as a cyclopentadienyl derivative of a transition metal.

Metallocene catalysts are known to those skilled in the art. These metallocene catalysts differ from the catalysts known as Ziegler-Natta catalysts.

The metallocene catalysts of the invention may or may not be supported.

The monofilaments of the invention advantageously have an abrasion of less than or equal to 0.014%.

The abrasion of the monofilaments is determined by gravimetric measurement of the amount of fluff produced during the manufacture of a 300 m length of woven fabric, using the method described below in the experimental part. The abrasion value corresponds to the result of the formula described below in the experimental part, calculated for a woven fabric length of 300 m.

It is particularly advantageous for the monofilaments to have an abrasion of less than 0.014%. This is because, when the abrasion is greater than 0.014%, irregularities may be produced during weaving, due to too rapid fouling of the reeds. This may shorten the time intervals between cleaning operations, thereby reducing the productivity of the loom.

The monofilaments of the invention preferably have an abrasion of less than or equal to 0.005%.

It is appropriate for the monofilaments to possess a strength of at least 50 cN/tex for an elongation corresponding to the maximum tensile stress (elongation at break) at least equal to 20%. This is because a strength of less than 50 cN/tex has the drawback of increasing the number of yarn breakages during the weaving process.

The monofilaments of the invention advantageously have a mechanical constant of greater than or equal to 285.

The diameter of the monofilaments of the invention is advantageously greater than or equal to 0.05 mm.

The monofilaments of the invention may include additives. Advantageously, the monofilaments include 0.01 to 20% by weight of additive relative to the weight of polypropylene.

Advantageously, it is appropriate to use as additive a polypropylene/polyethylene copolymer having a melting point ≧140° C. Advantageously, this additive is present in a proportion of 1 to 20% by weight relative to the weight of polypropylene.

The invention also relates to a process for manufacturing the monofilaments of the invention, which comprises the steps of extrusion/melt-spinning, drawing and winding of the polypropylene.

The polypropylene-based monofilaments of the invention may be obtained using conventional spinning methods. They are generally obtained by extrusion/melt-spinning, cooling in a water bath when the monofilament titre is greater than or equal to 0.05 mm, drawing and winding.

When the monofilaments of the invention include an additive, the additive is generally added to the polypropylene upstream of an extruder, before the spinning.

The monofilaments according to the invention are particularly suitable for the manufacture of two-dimensional high-performance articles, and especially for the manufacture of such articles in the field of filtration. These articles, when they are intended for filtration, especially in the chemical, pharmaceutical and food industries, are preferably woven fabrics.

The invention will now be described in greater detail with the aid of examples.

Polymer

As polymer, various polypropylenes were used during the trials, these being obtained by polymerizing propylene in the presence of a metallocene catalyst, the melt flow index (MFI) of the polypropylenes at 230° C./2.16 kg being variable.

Polymer A: a polypropylene sold by Atofina under the reference MR 15 2002®, having a melt flow index (MFI) at 230° C./2.16 kg of 15 g/10 min.

Polymer B: a polypropylene sold by Atofina under the reference MR 25 2001®, having a melt flow index (MFI) at 230° C./2.16 kg of 25 g/10 min.

Polymer C: a polypropylene sold by Basell Metocene under the reference HM 562 S®, having a melt flow index (MFI) at 230° C./2.16 kg of 30 g/10 min.

Each time 300 kg of polypropylene granules were employed, using 25 kg drums.

The polypropylene granules and the optional additive granules were fed directly into the extruder and melted.

Spinning Conditions

| | |
|---|---|
| Extruder: | Diameter: 40 mm; barrel length: |
| | L/D = 25 |
| Extruder pressure: | 80 bar |
| | Flow rate: 16.5 kg/h |
| | 5 heating zones |
| Spinning pump: | Metered volume: 10 cm³/revolution |
| Spinning unit: | Electrically heated |
| Metering pump: | 21 revolutions/min. |
| Spinnerets: | Diameter: 0.7 mm |
| | Capillary length: 3 × D |
| Water bath: | Distance between spinneret and |
| | water bath: 45 mm |
| | Temperature: 40° C. (Example 1) or |
| | 50° C. (Example 2). |

Drawing Stages and Heating Channels
Drawing stage 1: 7 rolls; roll diameter: 230 mm; 1 heating channel
Drawing stage 2: 7 rolls; roll diameter: 230 mm; 1 heating channel
Drawing stage 3: 7 rolls; roll diameter: 230 mm; 2 heating channels
Drawing stage 4: 4 rolls; roll diameter: 230 mm.
   Measurement Methods
   Melt flow index according to ASTM D1238
   Determination of the titre according to SN 197 012 and SN 197 015, supplemented with DIN 53830/
   The mechanical constant MC is calculated using the following formula:
      MC=\sqrt{D}×F[cN/tex]

where D denotes the elongation in [%] and F denotes the strength in [cN/tex]
Determination of the thermal shrinkage according to BISFA (Chapter 11 of the standard protocol: “Determination of the thermal shrinkage in hot air”), carried out under the following conditions:
   tension: 0.02 cN/dtex
   temperature: 120° C.
   duration: 10 min.
      Description of the Abrasion Tests

Manufacture of Sectional Beams

The sectional beams, of 1000 m each, were manufactured using monofilaments from 60 bobbins of the various versions.

Weaving Trials

The weaving trials were carried out on a ribbon loom. Maximum possible production: 4000 revolutions/min.

The shed was formed by excentrics

Working mode: no weft re-entry

Density of warp yarns: 22.80 yarns/cm

Reed: opening: 0.175 mm

dent thickness: 0.264 mm
dent width: 7.0 mm
   Speed of rotation of the loom: 1000 revolutions/min.
   Weaving speed: 10 m/h
   Weave: L1/1 (plain weave) cloth.
   Evaluation of the Abrasion Behaviour:
visual evaluation of the reeds
gravimetric determination of the amount of fluff produced.

In the visual determination, the reeds are photographed after a period of operation corresponding to a 300 m length of fabric, and a rating is assigned to them.

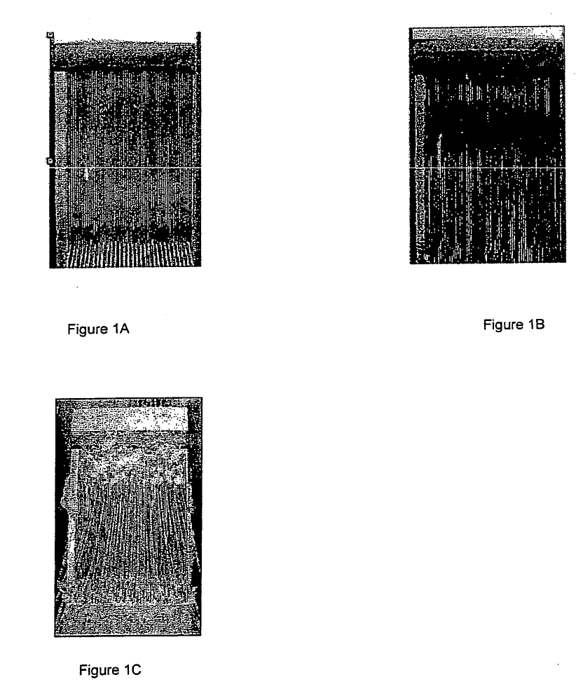

FIGS. 1A, 1B and 1C show photographs of the reeds after a weaving trial according to the method described above. FIG. 1A corresponds to Example 1, FIG. 1B to Example 2 and FIG. 1C to the comparative example. The reeds of FIGS. 1A and 1B show practically no fluff, whereas that of FIG. 1C shows a not insignificant amount of fluff.

The evaluation of the abrasion behaviour using the gravimetric method is described below. To do this, all of the fluff formed after a period of operation corresponding to a fabric length of 300 m is collected, weighed and expressed with respect to the warp yarns using the following formula:

$$\% fluff deposit = \frac{mass of deposit \times 100}{No . of warp yarns \times \frac{warp yarn length \times titre}{10000}}$$

The abrasion behaviour may also be evaluated using the same gravimetric method described above, but for a fabric length of 1000 m.

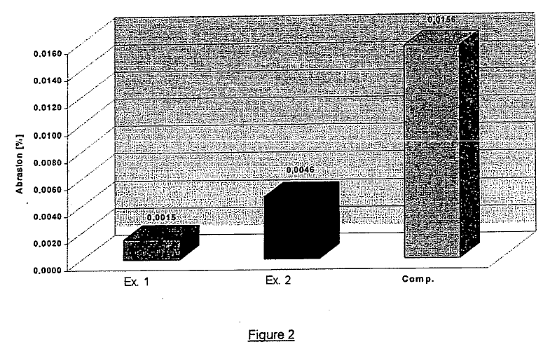

FIG. 2 shows the results in terms of abrasion behaviour of Examples 1 and 2 and the comparative example.

### EXAMPLES

### Example 1

Monofilaments were obtained from granules of polymer A using a method and under the conditions described above.

### Example 2

Monofilaments were obtained from granules of polymer A and from granules consisting of polypropylene and of PP/PE modified polyolefin, with a melting point >140° C., using a method and under the conditions described above.

### Example 3

Monofilaments were obtained from granules of polymer B according to a method and under the conditions described above.

### Example 4

Monofilaments were obtained from granules of polymer C according to a method and under the conditions described above.

The examples are summarized in Table 1.

TABLE 1

| | Example | | | |
|---|---|---|---|---|
| | 1 | 2 | 3 | 4 |
| Polymer | A | A | B | C |
| Additive (% by weight) | — | 10 | — | — |
| Diameter [mm] | 0.15 | 0.15 | 0.15 | 0.15 |
| Strength [cN/tex] | 61.9 | 56.8 | 61.6 | 59.0 |
| Elongation corresponding | 31.2 | 35.3 | 33.0 | 34.6 |
| to the maximum tensile | | | | |
| stress [%] | | | | |
| Mechanical constant | 345 | 337 | 354 | 347 |
| Thermal shrinkage (%) | 4.0 | 3.3 | 4.4 | 7.4 |
| Abrasion (%) (300 m of | 0.0015 | 0.0046 | 0.0084 | 0.0076 |
| fabric) | | | | |
| Abrasion (%) (1000 m of | 0.0085 | 0.0116 | 0.0245 | 0.0096 |
| fabric) | | | | |

### Comparative Example

Monofilaments were obtained in accordance with Example 2 of Patent Application WO 03/048434. Their abrasion was 0.0156% (300 m of fabric).

The monofilaments according to the invention, in particular the monofilaments having a diameter ≧0.050 mm, are suitable for the manufacture, without any abrasion, of fabrics intended for filtration.

Thanks to the monofilaments according to the invention, it is possible to weave the polypropylene monofilament practically without any abrasion and to considerably increase the operation time of the loom. This mono-filament is particularly suitable for the manufacture of fabrics that are used for filtration in the chemical, pharmaceutical and food industries.

1-8. (canceled)

9. An abrasion-resistant polypropylene-based monofilaments, wherein the polypropylene is obtained by polymerizing propylene in the presence of a metallocene catalyst.

10. The monofilaments according to claim 9, having an abrasion of less than or equal to 0.014%.

11. The monofilaments according to claim 10, wherein the abrasion value is less than or equal to 0.005%.

12. The monofilaments according to claim 9, having a strength of at least 50 cN/tex for an elongation corresponding to the maximum tensile stress (elongation at break) at least equal to 20%.

13. A process for manufacturing the monofilaments as defined in claim 9, comprising the steps of extrusion/melt-spinning, drawing and winding of the polypropylene.

14. A two-dimensional high-performance article comprising the monofilaments as defined in claim 9.

15. A fabric for filtration comprising the monofilaments as defined in claim 9.
